(19) United States
(12) Patent Application Publication
(10) Pub. No.: US 2009/0226355 A1
(43) Pub. Date: Sep. 10, 2009

(54) METHODS OF FORMING HYDROGENATED METALLOID COMPOSITIONS VIA POLYMERIZATION

(76) Inventors: Richard M. Laine, Ann Arbor, MI (US); Daniel Nielsen, Burlington, VT (US); Max Shtein, Ann Arbor, MI (US)

Correspondence Address: HARNESS, DICKEY & PIERCE, P.L.C., P.O. BOX 828, BLOOMFIELD HILLS, MI, 48303, US

(21) Appl. No.: 12/399,298

(22) Filed: Mar. 6, 2009

Related U.S. Application Data
(60) Provisional application No. 61/034,846, filed on Mar. 7, 2008.

(51) Int. Cl. C01B 33/04; C01B 6/06

(52) U.S. Cl. 423/347; 423/645

(57) ABSTRACT

Methods of producing semiconductor materials via polymerization techniques are provided. The methods include reacting a precursor compound containing a metalloid semiconductor element, such as silicon or germanium, with a catalyst to form a polymer composition. The polymer precursor is then decomposed to form an electrically conductive hydrogenated composition containing silicon or germanium. The methods employ relatively safe raw materials and products and result in high yield reactions. Moreover, the polymers can be applied in liquid form and can be used as an “ink” or liquid to selectively coat a substrate.

### CROSS-REFERENCE TO RELATED APPLICATION

This application claims the benefit and priority of 61/034,846, filed on Mar. 7, 2008. The entire disclosure of the above application is incorporated herein by reference.

### FIELD

The present disclosure relates to processes that form semiconductor compositions and more specifically to methods of forming hydrogenated silicon and/or hydrogenated germanium via polymerization techniques and selected modification by thermal or plasma processes.

### BACKGROUND

The statements in this section merely provide background information related to the present disclosure and may not constitute prior art.

There is increasing interest in a new field of electronic materials currently under development targeting the creation of printable and imprintable inks for electronic and photonic circuitry. Until recently, research in these areas has focused primarily on printable organics for transistors, photovoltaics and organic light emitting diodes. It would be desirable to have a process developing polymers that provide pure metals/metalloids, and in particular silicon and/or germanium, for printing anything from devices on polymer substrates to polysilicon photovoltaics.

### SUMMARY

This section provides a general summary of the disclosure, and is not a comprehensive disclosure of its full scope or all of its features.

In various aspects, the present disclosure provides methods of making a hydrogenated semiconductor metalloid composition that comprises forming a polymer comprising at least one semiconductor metalloid element according to the reaction represented by Reaction (V):

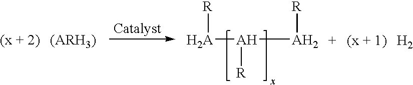

wherein A is selected from semiconductor metalloid elements: silicon (Si) and/or germanium (Ge); ARH₃ is a precursor compound that includes an R group comprising at least two carbon atoms and selected from: linear alkyl groups, branched alkyl groups, cycloalkyl groups, and combinations thereof, and x is a molar amount of the precursor compound which reacts in the presence of at least one catalyst to form the polymer. The method further includes decomposing the polymer for a duration and at a temperature sufficient to form the hydrogenated semiconductor metalloid composition.

In yet other aspects, the present disclosure provides methods of making a hydrogenated silicon composition. For example, in certain aspects, such methods include forming a polysilane polymer according to the reaction represented by Reaction (I):

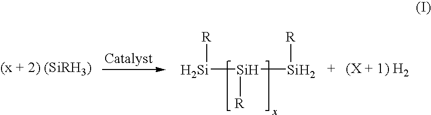

where SiRH₃ is a precursor silane compound that includes an R group comprising at least two carbon atoms and is selected from: linear alkyl groups, branched alkyl groups, cycloalkyl groups, and combinations thereof. Further, x is a molar amount of the precursor silane compound which reacts in the presence of at least one catalyst to form the polysilane polymer. The method also includes decomposing the polysilane polymer for a duration and at a temperature sufficient to form the hydrogenated silicon.

In yet other aspects, the present disclosure provides a method of making a hydrogenated silicon composition comprising: forming a polysilane polymer according to the reaction represented by Reaction (I):

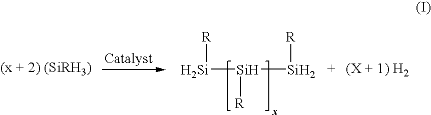

where SiRH₃ is a precursor silane compound that includes an R group comprising at least two carbon atoms and is selected from: linear alkyl groups, branched alkyl groups, cycloalkyl groups, and combinations thereof, where x is a molar amount of the precursor silane compound which reacts in the presence of at least one catalyst to form the polysilane polymer. The polysilane polymer formed in Reaction (I) is decomposed for a duration and at a temperature sufficient to form the hydrogenated silicon. The decomposing proceeds according to Reaction (II):

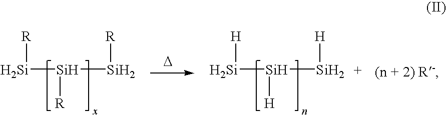

where x ranges from greater than or equal to about 5 to less than or equal to about 1000, and n relates to the degree of hydrogenation related to an amount of energy applied during the decomposing of the polysilane polymer and is greater than or equal to about 5.

Further areas of applicability will become apparent from the description provided herein. The description and specific examples in this summary are intended for purposes of illustration only and are not intended to limit the scope of the present disclosure.

### DRAWINGS

The drawings described herein are for illustration purposes only and are not intended to limit the scope of the present disclosure in any way.

FIG. 1 shows attenuated total reflection (ATR) Fourier transform infrared spectroscopy (FTIR) of cyclohexylsilane;

FIG. 2 shows the gel permeation chromatography elution data (GPC) analyses of the polymerization of cyclohexylsilane (prepared neat, at room temperature of about 25° C. (RT), with less than or equal to 10 mol % dimethyltitanocene (Cp₂TiMe₂) catalyst, with samples taken at indicated processing times);

FIG. 3 shows the gel permeation chromatography elution data (GPC) analyses of the polymerization of cyclohexylsilane (prepared neat, at 50° C., with less than or equal to about 10 mol % dimethyltitanocene (Cp₂TiMe₂) catalyst, with samples taken after the indicated processing times);

FIG. 4 shows the gel permeation chromatography elution data (GPC) analyses of the polymerization of cyclohexylsilane (prepared in toluene, at room temperature of about 25° C. (RT), with about 10 mol % dimethyltitanocene (Cp₂TiMe₂) catalyst, with samples taken after the indicated processing times);

FIG. 5 shows the gel permeation chromatography elution data (GPC) analyses of the polymerization of cyclohexylsilane (prepared neat, at room temperature of about 25° C. (RT), with about 10 mol % dimethyltitanocene (Cp₂TiMe₂) catalyst, with samples taken after the indicated processing times);

FIG. 6 is a graph showing FTIR (ATR) of a polycyclohexylsilane sample (prepared neat, at 50° C., with about 10 mol % dimethyltitanocene (Cp₂TiMe₂) catalyst);

FIG. 7 shows an exemplary pyrolysis product formed from a starting material comprising polycyclohexylsilane subjected to the teachings of the present disclosure;

FIG. 8 includes a scanning electron micrograph (SEM) and electron dispersive spectroscopy (EDS) analysis of the pyrolysis product of polycyclohexylsilane formed in accordance with the teachings of the present disclosure;

FIG. 9 shows the ATR-FTIR of polycyclohexylsilane in cyclohexane after column chromatography to separate the titanocene catalyst;

FIG. 10 shows a matrix-assisted laser desorption/ionization, time-of-flight mass spectrometer (MALDI-TOF) spectrum of a column of chromatographed oligocyclohexylsilane similar to the sample in FIG. 9;

FIG. 11 shows a thermogravimetric analysis (TGA) of oligocyclohexylsilane prepared in accordance with the teachings of the present disclosure;

FIG. 12 shows an ATR-FTIR of dimethyltitanocene;

FIG. 13 shows a ¹H NMR (400 MHz) of cyclohexylsilane;

FIG. 14 shows the gel permeation chromatography elution data (GPC) analyses of the polymerization of cyclohexylsilane (prepared in toluene, at 50° C., with less than or equal to about 10 mol % dimethyltitanocene (Cp₂TiMe₂) catalyst, with samples taken after the indicated processing times);

FIG. 15 shows the gel permeation chromatography elution data (GPC) analyses of the polymerization of cyclohexylsilane (prepared in cyclohexene, at 50° C., with less than or equal to about 5 mol % dimethyltitanocene (Cp₂TiMe₂) catalyst, with samples taken after the indicated processing times);

FIG. 16 shows the gel permeation chromatography elution data (GPC) analyses of the polymerization of cyclohexylsilane (prepared in cyclohexene, at 50° C., with less than or equal to about 10 mol % dimethyltitanocene (Cp₂TiMe₂) catalyst, respectively, with samples taken after 90 hours of processing);

FIG. 17 shows the gel permeation chromatography elution data (GPC) analyses of the polymerization of cyclohexylsilane (prepared in cyclohexene, at 50° C., with less than or equal to about 5 and 10 mol % dimethyltitanocene (Cp₂TiMe₂) catalyst, respectively, with samples taken after 90 hours of processing);

FIG. 18 shows the gel permeation chromatography elution data (GPC) analyses of the polymerization of cyclohexylsilane (prepared neat, at 50° C., with less than or equal to about 0.5 mol % dimethyltitanocene (Cp₂TiMe₂) catalyst, with samples taken after the indicated processing times); and

FIG. 19 shows the gel permeation chromatography elution data (GPC) analyses of polymerization of cyclohexylsilane (prepared using less than or equal to about 0.1 mol % dimethyltitanocene (Cp₂TiMe₂) catalyst, with samples taken after the indicated processing times).

### DETAILED DESCRIPTION

The following description is merely exemplary in nature and is not intended to limit the present disclosure, application, or uses.

The present teachings pertain to the formation of hydrogenated semiconductor metal or metalloid compositions, including silicon (Si) and germanium (Ge). In various aspects, the present disclosure provides new methods of forming metalloid materials, which comprise Si and/or Ge, such as substrates, lines, thin films and patterns. In various aspects, the methods of the present disclosure are useful in applying viscous printable polymers and/or polymer precursors, where upon heating or exposure to other energy sources, the polymer and/or polymer precursor transforms to exhibit the properties of pure silicon metal and/or pure germanium, for use in the fabrication of a wide variety of electronic, sensor, photovoltaic and related photonic devices.

Prior attempts to form silicon substrates via various reactions have suffered from low yields and often include hazardous or expensive raw materials or processing conditions. For example, a polyhydridosilane (e.g., a silicon hydride composition) made from a cyclic silane produced via Reaction (A) below is generated in very low yields. These products were then photo polymerized via Reaction (B) to low molecular weight (M_{w}≈2600 Da) somewhat crosslinked materials, which were soluble only in the monomer. All of these materials are highly air sensitive and, under some conditions, highly flammable, for example oxidizing very easily in air.

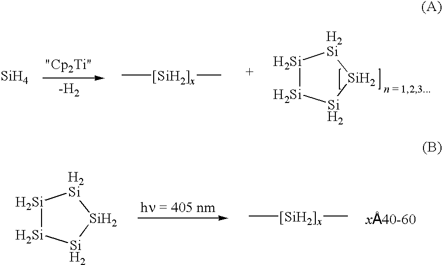

Spin coating of such material followed by heating to 540° C. created hydrogenated silicon having a purported composition of approximately SiH_{0.1} (0.3 wt %). Materials formed in this manner further require laser annealing (recrystallization) to offer properties required for traditional CVD transistors. This process suffers from disadvantages including an extremely low yield precursor system and a starting material of SiH₄, an explosive gas. Various other efforts to make “printable silicon” have also met with limited success and are difficult to scale-up to an industrially or commercially practicable process.

The present disclosure provides a new method of producing hydrogenated semiconductor metalloid based compositions, such as a hydrogenated polysilicon and/or hydrogenated polygermanium. The inventive methods generally use a precursor containing a metalloid element that is relatively stable in air. Moreover, the methods of the present disclosure provide the potential for printing and reactants and/or products that are soluble in a variety of solvents. In various aspects, a method is provided for forming a hydrogenated silicon composition comprising hydrogen and silicon, also referred to herein as hydrogenated polysilicon. In other aspects, a method is provided for forming a hydrogenated germanium composition comprising hydrogen and germanium, also referred to herein as hydrogenated polygermanium. The present disclosure contemplates methods of forming alloy compositions of silicon and/or germanium. While in certain aspects, the inventive concepts described herein are particularly suitable for a silicon-based composition; the present teachings are equally applicable to other semiconductor metalloids, such as germanium and the like, which are likewise contemplated by the present teachings. Thus, the discussion contained herein pertaining to silicon in certain embodiments should not be construed in a restrictive or limiting manner.

In various aspects, the hydrogenated metalloid composition formed in accordance with the teachings of the present disclosure has greater than or equal to about 85 wt. % of a metalloid element (e.g., silicon and/or germanium) per the total amount of hydrogenated metalloid composition neglecting any impurities (thus less than or equal to about 15 wt. % hydrogen), optionally greater than or equal to about 90 wt. % (less than or equal to about 10 wt. % hydrogen), optionally greater than or equal to about 95 wt. % (less than or equal to about 5 wt. % hydrogen), optionally greater than or equal to about 97 wt. % (less than or equal to about 3 wt. % hydrogen), optionally greater than or equal to about 98 wt. % (less than or equal to about 2 wt. % hydrogen), optionally greater than or equal to about 98.5 wt. % (less than or equal to about 1.5 wt. % hydrogen), and in certain aspects, optionally greater than or equal to about 99 wt. % (less than or equal to about 1 wt. % hydrogen), and in certain aspects, optionally greater than or equal to about 99.5 wt. % (thus less than or equal to about 0.5 wt. % hydrogen). In embodiments where the hydrogen present in the hydrogenated metalloid composition is equal to 0.1 wt. %, the composition can alternately be expressed as AHₓ where x=0.03, where A is the metalloid element, such as Si and/or Ge.

Thus, in various aspects, the present disclosure generally provides methods of making a hydrogenated semiconductor metalloid composition comprising forming a polymer comprising at least one semiconductor metalloid element according to the reaction represented by Reaction (V):

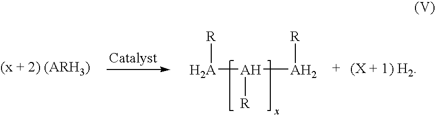

By “polymer” it is meant that the product formed may include monomers, oligomers, copolymers, and the like, depending on the extent of reaction. A is the semiconductor metalloid element selected from elements of Groups 13 or 14 of the IUPAC periodic table, such as silicon (Si) and/or germanium (Ge). Thus, A is selected to be silicon (Si) and/or germanium (Ge). ARH₃ is a precursor compound that includes a hydrocarbon R group comprising at least two carbon atoms and selected from: linear alkyl, branched alkyl, cycloalkyl, and combinations thereof, wherein x is a molar amount of the precursor compound which reacts in the presence of at least one catalyst to form the polymer. In various aspects, the polymer comprising at least one semiconductor metalloid element has energy applied for a duration sufficient to form the hydrogenated semiconductor metalloid composition. The hydrogenated semiconductor metalloid composition can have energy applied such that the final composition is optionally amorphous, partially crystalline, with seeding crystalline, and optionally epitaxial morphology.

In certain aspects, the decomposition reaction includes applying energy via heating and proceeds according to Reaction (VI):

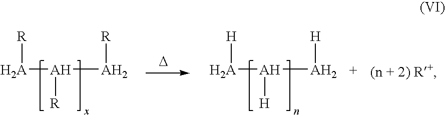

where n relates to the length or duration and temperature of heat applied to the polymer during the decomposing process. In other words, n relates to the degree of hydrogenation, which is related to an amount of energy applied during the decomposing Reaction VI of the polymetalloid polymer, wherein n is less than or equal to about 0.1% by weight hydrogen per total mass of the hydrogenated metalloid composition.

In certain aspects, the teachings of the present disclosure provide a hydrogenated silicon composition having greater than or equal to about 85 wt. % silicon per the total amount of hydrogenated silicon composition neglecting any impurities (thus less than or equal to about 15 wt. % hydrogen), optionally greater than or equal to about 90 wt. % (less than or equal to about 10 wt. % hydrogen), optionally greater than or equal to about 95 wt. % (less than or equal to about 5 wt. % hydrogen), optionally greater than or equal to about 97 wt. % (less than or equal to about 3 wt. % hydrogen), optionally greater than or equal to about 98 wt. % (less than or equal to about 2 wt. % hydrogen), optionally greater than or equal to about 98.5 wt. % (less than or equal to about 1.5 wt. % hydrogen), and in certain aspects, optionally greater than or equal to about 99 wt. % (less than or equal to about 1 wt. % hydrogen), and in certain aspects, optionally greater than or equal to about 99.5 wt. % (thus less than or equal to about 0.5 wt. % hydrogen). In embodiments where the hydrogen present in the hydrogenated silicon is equal to 0.1 wt. %, the composition can alternately be expressed as SiHₓ where x=0.03.

In certain variations, the method of making a hydrogenated silicon comprises forming a polysilane polymer according to the reaction represented by Reaction (I):

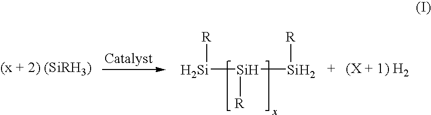

wherein SiRH₃ is a precursor silane compound and

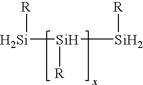

is the product formed, a polysilane polymer.

The R group is a hydrocarbon that comprises at least two carbon atoms (C₂). The R group is selected such that upon application of heat and/or energy, the R group is easily removed or eliminated, for example as an RH group. The R group is optionally selected from: linear alkyl groups, branched alkyl groups, cycloalkyl groups, and combinations thereof. In certain aspects, the alkyl or cycloalkyl group may optionally be substituted, unsaturated, or contain an additional functional group. It should be noted that while R is shown as being a single R group in Reaction (1), R may also include a plurality of distinct R groups achieved by selecting a mixture of precursor silane compounds having distinct R groups, as appreciated by those of skill in the art. By way of example, exemplary preferred R groups include methyl, ethyl, n-propyl, isopropyl, n-butyl, 2-butyl, isobutyl, tert-butyl, n-pentyl, isopentyl, neopentyl, tert-pentyl, hexyl, heptyl, n-octyl, isooctyl, nonyl, decyl, dodecyl, n-dodecyl, cyclopentyl, cyclohexyl, cycloheptyl, methylcyclohexyl, and combinations and isomers thereof. In certain aspects, particularly suitable R groups are selected from cycloalkyl groups, such as cyclopentyl, cyclohexyl, cycloheptyl, and/or methylcyclohexyl or alkyl groups having C₄-C₅, for example, tert-butyl, iso-butyl, and isopentyl. In certain aspects, the R group is selected to be a cyclohexyl group.

In Reaction (I), x represents a molar amount of the precursor silane compound which reacts in the presence of at least one catalyst to form the polysilane polymer. Thus the molecular weight of the polysilane polymer is determined by the amount of precursor silane present at the beginning of the reaction, as well as based on reaction conditions, such as temperature, pressure, and duration. In certain aspects, x can range from 5 to less than or equal to 1000. In certain aspects, Reaction (1) is conducted in an inert atmosphere, for example in flowing argon (Ar) or nitrogen (N₂), at atmospheric pressure. The precursor silane compound can be reacted in the presence of at least one catalyst as a neat solution or in a solvent, such as cyclohexane. A byproduct of Reaction (1) is hydrogen gas. In certain aspects, Reaction (I) is conducted at a temperature of about 20° C. to about 60° C.

Suitable catalysts contemplated by the present disclosure include titanium, bis(η⁵-2,4-cyclopentadien-1-yl)dimethyl-(Cp₂Ti-Me₂), also referred to as dimethyltitanocene, hafnium (Hf), zirconium (Zr), rhodium (Rh), and mixtures thereof, by way of example. Reaction (I) includes at least one catalyst, which can comprise dimethyltitanocene. In certain aspects of the present disclosure, the method may further include making the catalyst by reacting dichlorotitanocene with CH₃Li in an inert atmosphere to form dimethyltitanocene (and lithium chloride as a byproduct), as will be described in more detail below.

The method of making a hydrogenated silicon composition further comprises decomposing the polysilane polymer formed in Reaction (I) by applying energy for a duration sufficient to form the hydrogenated silicon, for example in a pyrolysis reaction. The method of decomposing the polysilane polymer by applying energy includes for example, applying radiant energy, laser energy, microwave energy, plasma, non-thermal plasma (NTP or so-called “cold plasma”). The extent of radical elimination (R) is generally determined by the energy of the decomposition method applied. For example, the extent of radical elimination (R) relates to the residual hydrogen present and the degree of crystallinity of the final product, which relates to the amount of heat/energy applied to the polysilane polymer. As referred to herein, applying “heat” is intended to generally cover application of various types of energy to the system to decompose the polysilane polymer.

In Reaction (II), the polysilane polymer is heated to form the hydrogenated silicon composition. R is a radical leaving group, which typically forms a thermodynamically stable byproduct. As noted above, the length of the heating or energy application step, along with the temperatures/energy required is typically dependent on the R group or groups present in the polysilane polymer, substrate stability or stability of other components, as appreciated by those of skill in the art. Further, the longer the duration and higher the heat/energy applied during the heating step, the greater the amount of hydrogen that will be driven off from the hydrogenated silicon composition.

Thus, the present methods include heating the polysilane polymer at temperature ranges of greater than or equal to about 350° C. to less than or equal to about 1,000° C., in certain aspects, optionally greater than or equal to about 600° C.; and optionally greater than or equal to about 800° C. In other aspects, plasma or microwave energy is applied for a suitable duration of time to achieve the desired pyrolysis/end product properties, for example achieving a predetermined hydrogenation level in final product. In various aspects, the heating of the polysilane polymer is conducted in an inert atmosphere, for example, in a flowing argon (Ar) environment.

In certain aspects, the heating/pyrolysis is conducted until the hydrogenated silicon composition contains the relative levels of silicon and hydrogen discussed above. By way of non-limiting example, the heating step is optionally conducted until the hydrogenated silicon composition contains less than about 0.1% by weight hydrogen per total mass of the hydrogenated silicon composition, which is SiHx, where x=0.03.

By way of example, the silane composition final product can be represented by the structure:

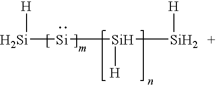

where a ratio of m:n ranges from 1000:1 to 10:1, for example. For example, the heating/pyrolysis reaction can also be represented by Reaction (II):

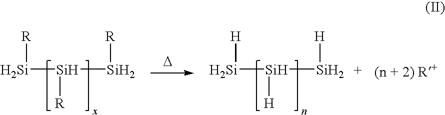

where x ranges from greater than or equal to 5 to greater than or equal to 1000 and n is greater than or equal to 5.

In certain aspects, the precursor silane compound is cyclohexylsilane (C₆H₁₁SiH₃), so the R group is selected to be cyclohexyl. In certain alternate aspects of the present disclosure, the cyclohexylsilane precursor silane compound is formed according to Reaction (III) below:

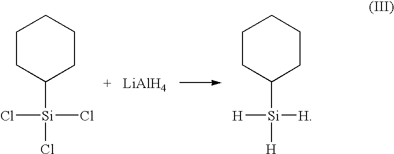

In certain aspects, Reaction (III) can be conducted at a temperature of about −10° C. to about 10° C., optionally around 0° C. The trichlorocyclohexylsilane is reacted with lithium aluminum hydride (LiAlH₄), optionally in a solvent comprising ether.

In accordance with certain aspects of the present teachings, it is an objective to create a polymer system where cleavage between a Si—C bond is favored with coincident generation of an Si—H bond and formation of a volatile but stable cyclic alkene, which generally does not undergo thermal hydrosilylation. Thus, if Reaction (IV) described above is conducted by using a silane precursor incorporating a cyclohexyl group, then a printable, yet air-stable, oligomer polymer is generated that decomposes to hydrogenated amorphous silicon.

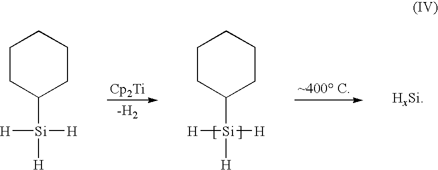

In accordance with the principles of the present disclosure, a hydrogenated polysilane compound is formed and transformed to a hydrogenated silicon material at temperatures currently used in wafer processing electronic processing. In certain aspects, after forming the polysilane polymer in Reaction (I), the polymer is in a flowable liquid and/or gel phase. Thus, the methods of the present disclosure optionally further comprise applying the polysilane polymer (or other metalloid precursor polymer) to a substrate to form a layer thereon after forming the polysilane polymer (or other metalloid precursor polymer) via the silane precursor, but prior to the heating, where the polymer is pyrolyzed and solidifies to the hydrogenated silicon material on the substrate. As noted previously, the polysilane polymer (or other metalloid precursor polymer) can be applied in the same manner to form lines, thin films, and patterns, which are intended to be included in the general use of “substrate.” The applying step may be conducted by spin casting, solvent casting, ink jet printing, silk screening, lamination, coating and/or spreading, for example, with a doctor blade, extrusion, or other similar techniques for applying polymers to a substrate, as are well known to those of skill in the art.

### EXAMPLES

Cyclohexyltrichlorosilane is purchased from Gelest, Inc. Bis(cyclopentadienyl)titanium dichloride is purchased from Strem Chemicals, Inc. All other reagents are purchased from Sigma-Aldrich Co. Anhydrous ether is stored over molecular sieves, and toluene is distilled from sodium/benzophenone under nitrogen or argon.

Synthesis of Cyclohexylsilane

A 2 L three neck round bottom flask (with stir bar) with flash distillation flask (with stir bar for subsequent distillation) is dried under vacuum using a heat gun and cooled under nitrogen gas. Cyclohexyltrichlorosilane (100 g, 0.460 mol) is added dropwise to a stirred 1.0 M solution of lithium aluminum hydride (800 ml, 0.800 mol) in ether solvent at 0° C. The product HCl gas is passed through an oil bubbler to limit admission of moisture, and then a side arm flask of aqueous KOH to neutralize the gas. After chlorosilane addition is complete, the solution is stirred at ambient temperature and pressure over night. Thereafter, the reaction liquids are first flash distilled using a liquid N₂ trap, and then ether is distilled at ambient pressure (about 110° C. to remove all ether), and the cyclohexylsilane redistilled from traces of LiAlH₄ and salt byproduct impurities (e.g., LiCl and AlCl₃) as a clear colorless oil. A similar purification of cyclohexylsilane uses a Kugelrohr apparatus and is then redistilled.

Synthesis of Dimethyltitanocene Catalyst

A 50 ml Schlenk flask with stir bar is dried under vacuum using a heat gun, cooled under nitrogen gas, and wrapped in aluminum foil. Bis(cyclopentadienyl)titanium dichloride (0.390 g, 1.55 mmol) and 20 ml anhydrous ether are then added and cooled to 0° C. MeLi (1.6 M in ether) is added drop wise to the flask under nitrogen gas, and then allowed to warm to room temperature. After 2 additional hours the solution is filtered (0.2 μm nylon filter with syringe) into a 25 ml Schlenk flask under N₂, and the ether is removed in vacuo to yield a yellow/orange solid. This protocol is similar to those described by Clauss and Bestian in Justus Liebigs Ann. Chem., Vol. 654, p. 8-19 (1962), incorporated herein by reference in its entirety.

Synthesis of Polycyclohexylsilane

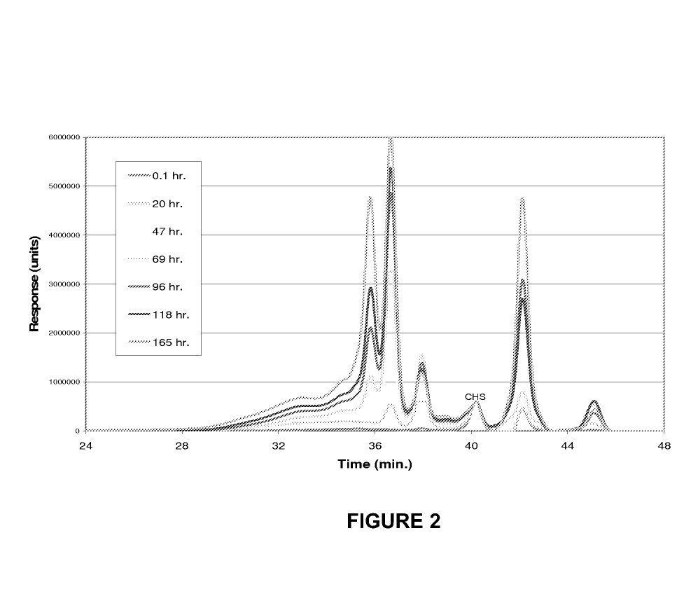

A 25 ml Schlenk flask with stir bar is dried under vacuum using a heat gun, and allowed to cool under N₂. To certain experiments, toluene or cyclohexene is used as solvent, and added to the Schlenk flask first, at 0° C. under N₂. An appropriate amount of cyclohexylsilane is added to the active dimethyltitanocene catalyst (0.1-10 mol %) in an ice bath under N₂. The solution is allowed to stir with the catalyst slowly changing to a purple color as it becomes active and the reaction mixture starts to produce H₂ gas. The reaction is stirred magnetically under N₂ for 4-6 days depending on the mol % catalyst added. Similarly, some reactions are carried out at ambient temperature and some are heated to 50° C., as indicated below. Polymerization reactions are sampled periodically and analyzed by GPC, as set forth in FIGS. 2-5.

NMR Analyses

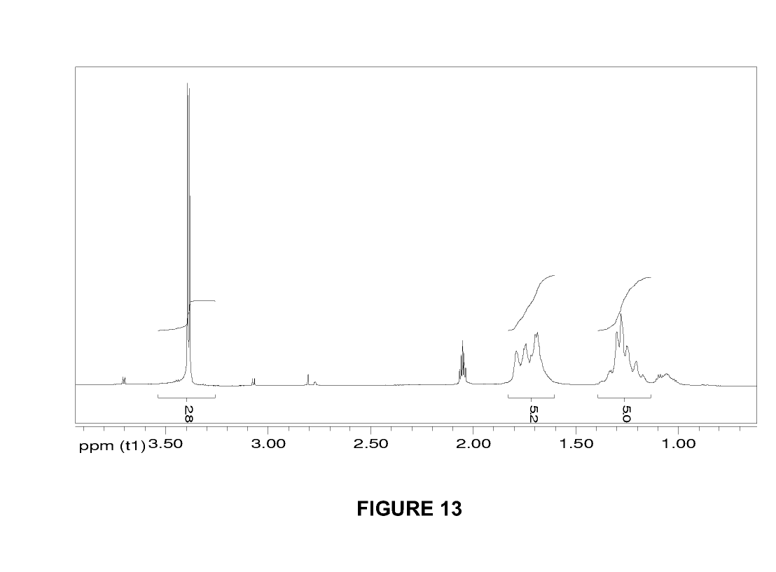

All H NMR spectra are performed in CDCl₃ and recorded on a Varian INOVA 400 MHz spectrometer. FIG. 13 reflects ¹H NMR results of cyclohexylsilane.

FTIR Analyses

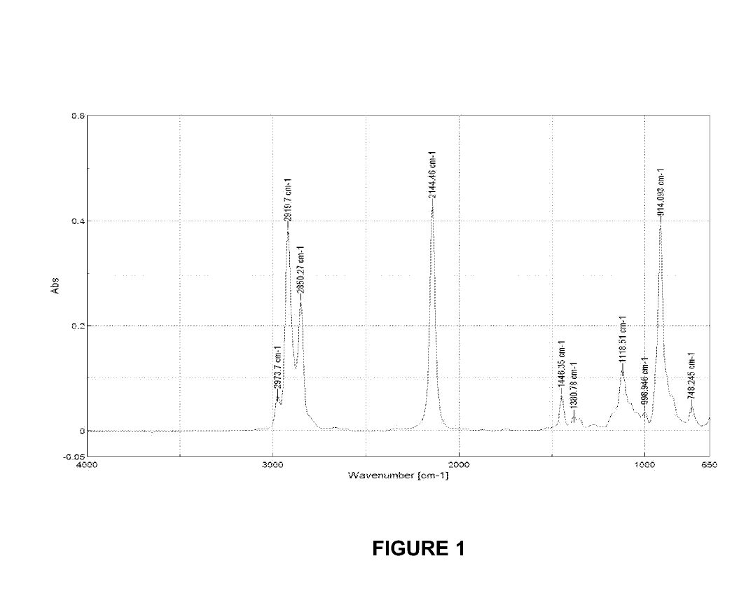

Diffuse reflectance infrared Fourier transform (DRIFT) spectra is obtained using a Galaxy 3000 spectrometer (Mattson Instruments, Inc.), or a Thermo-Fisher Nicolet 6700 FTIR, using a Praying Mantis DRIFT accessory (Harrick Scientific Products, Inc.). Optical grade potassium bromide (International Crystal Laboratories) is used as the supporting medium. Attenuated total reflectance (ATR) spectra are obtained neat using an FTIR 4100 (Jasco, Inc.) using a MIRacle diamond accessory. ATR-FTIR analyses are shown in FIGS. 1, 6, 9, and 12.

GPC Analyses

Gel permeation chromatography (GPC) spectra are obtained using a Waters GPC system, equipped with RI and UV detectors, a Styragel column set (7.8×300 mm, HR-high resolution 4, 3, 1, 0.5), and a PL-DCU data capture unit. The system is calibrated using polystyrene standards. Filtered (0.45 p.m.) THF is used as the mobile phase at a flow rate of 1.0 ml/min. Results are shown in FIGS. 2-5 and 14-19.

DSC-TGA-DTA Analyses

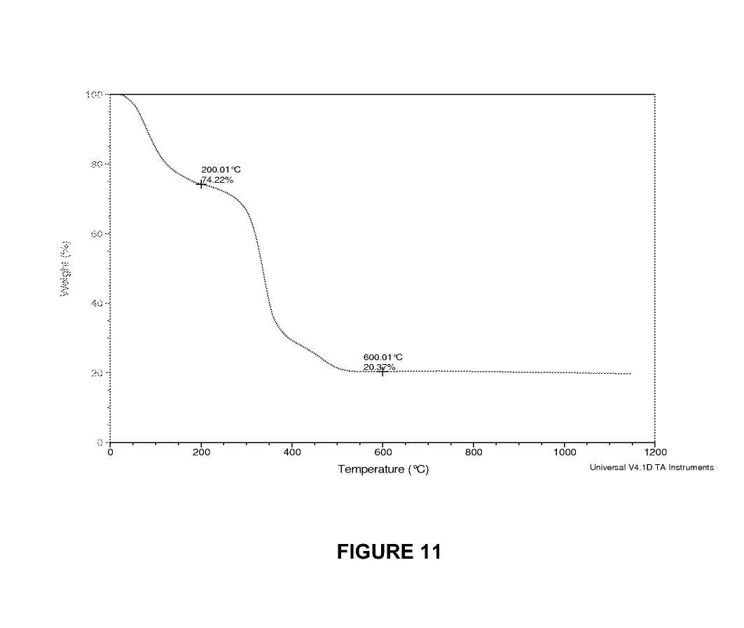

Differential scanning calorimetry (DSQ thermal gravimetric analysis (TGA) differential thermal analysis (DTA) are obtained using a DSC 2960 simultaneous TGA-DTA instrument (TA Instruments, Inc.). Samples (10-20 mg) are loaded in alumina pans, and the temperature is ramped (5° C./min.) to 1000° C. in N₂ or Ar gas (60 ml/min). FIG. 11 reflects TGA analysis of the polysilane polymer (oligocyclohexylsilane).

SEM/EDS Analyses

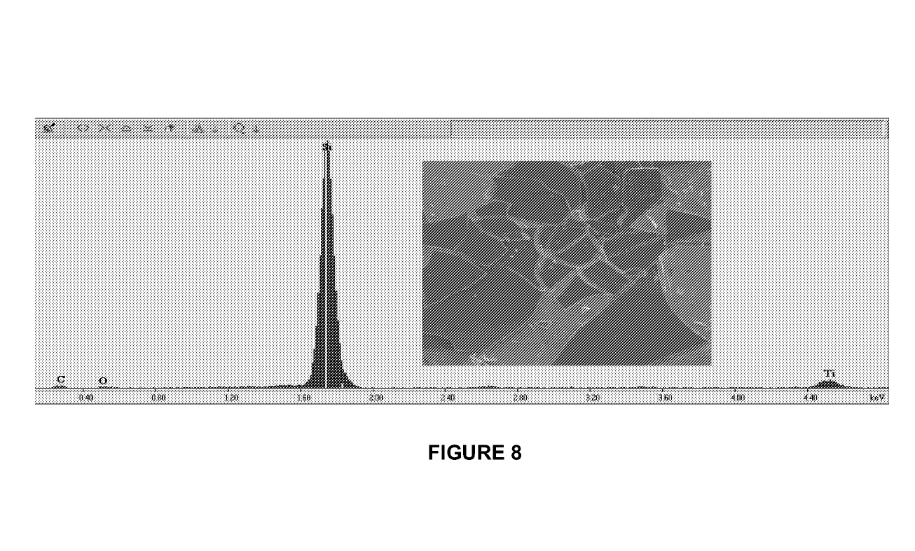

Philips XL30 Scanning Electron Microscope (SEM) combined with an Energy Dispersive Spectrometer (EDS) is used in the range of 10-25 keV for the image shown in FIG. 8.

Pyrolysis of Polycyclohexylsilane

Polycyclohexylsilane products are heated to about 600-about 1200° C. under N₂ or Ar gas, using a TGA-DTA instrument with alumina pans. Larger scale pyrolyses are run in a high temperature furnace (Lindberg Furnace available from Thermal Product Solutions, Inc.) under argon, heating to 600-1150° C. typically at a rate of 1° C./min. holding at maximum temperature for 3 h using a zirconia boat. Samples of 100-200 mg are deposited so as to coat the bottom of the boat and thereafter heated as noted. After the boat has been coated with sufficient amounts of decomposed and hydrogenated Si, a sample is then introduced and heated to form, at 800-1100° C., shiny thin silver films. These samples are then used for conductivity studies and also analyzed by electron dispersive spectroscopy (EDS). As shown in FIG. 11, the pyrolysis of polycyclohexylsilane is complete at 600° C.

Conductivity measurements are done using a Cascade Hall Effect four point probe test unit. Samples are set-up using the semiconductor parameter analyzer settings and connect the electrical wiring from the 4-pt probe station. Samples are placed in substrate holder, as level as possible. The fine height adjustment is done by the x-y-z stage. Gross height adjustment of the probes is done by loosening the post knob on the back of the probe station. After a rough adjustment, the sample is approached with the probe using the z component of the x-y-z stage. After contact is made between the sample and probes, the probes spring slightly back into the housing. The current is swept using standard scans and the conductivity determined.

### Results

In the examples conducted in accordance with the methods of the present disclosure, relatively pure, hydrogenated silicon having suitable conductivity is produced. The first step is the synthesis of the precursor silane compound (e.g., intermediate cyclohexylsilane), and then forming the polysilane (e.g., polycyclohexylsilane). The resulting material is then thermally converted to hydrogenated silicon. This material is then characterized and conditions are selected to provide materials with conductivities in the range of 10³-10⁴ Ω/square. The details of each of these steps are provided below.

### Synthesis

Cyclohexylsilane, produced per Reaction (III-a), is polymerized using an in situ generated dimethyltitanocene of Reaction (V), as the active catalyst to promote dehydrocoupling in Reaction (I-a). The resulting polymer is pyrolyzed under heat in an argon gas purge to produce relatively pure hydrogenated silicon Reaction (I-a). The synthesis reaction of polycyclohexylsilane is run at variable reaction conditions, in a neat/cyclohexane solvent; at room temperature or at 50° C.

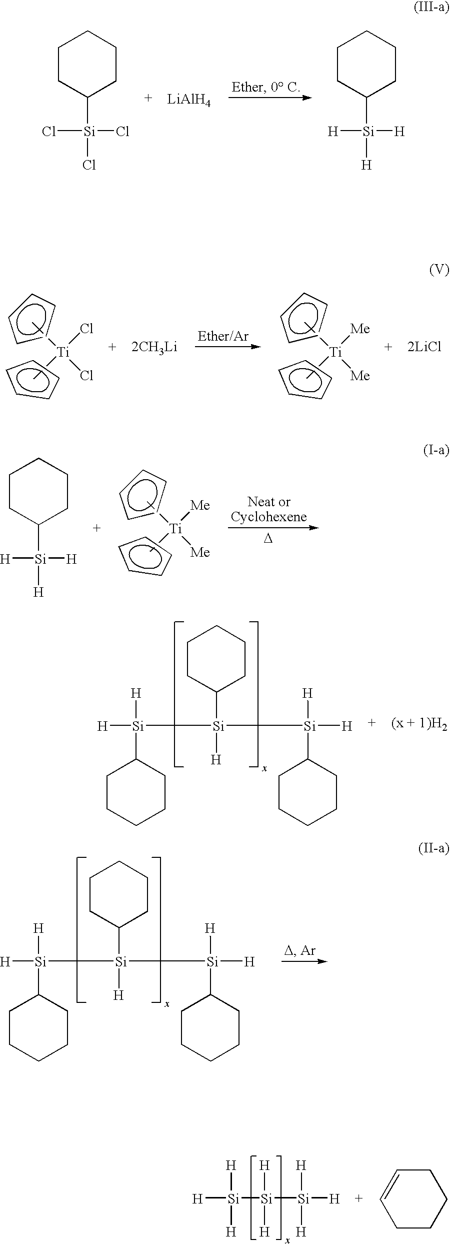

In a first step, as discussed above, precursor silane compound, cyclohexylsilane is synthesized. Oxidation of the silane to silanol is avoided by using flame dried glassware, sure-sealed reagents, and Schlenk techniques. FIG. 1 records the attenuated total reflection (ATR) FTIR of cyclohexylsilane. The IR spectrum shows νC—H bands in the 3000-2800 cm⁻¹ region, and a νSi—H band at 2144 and a δSi—H band at 914 cm⁻¹.

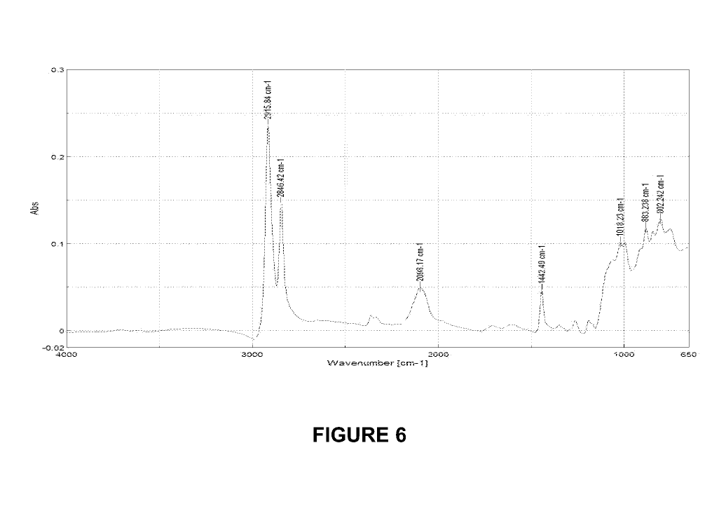

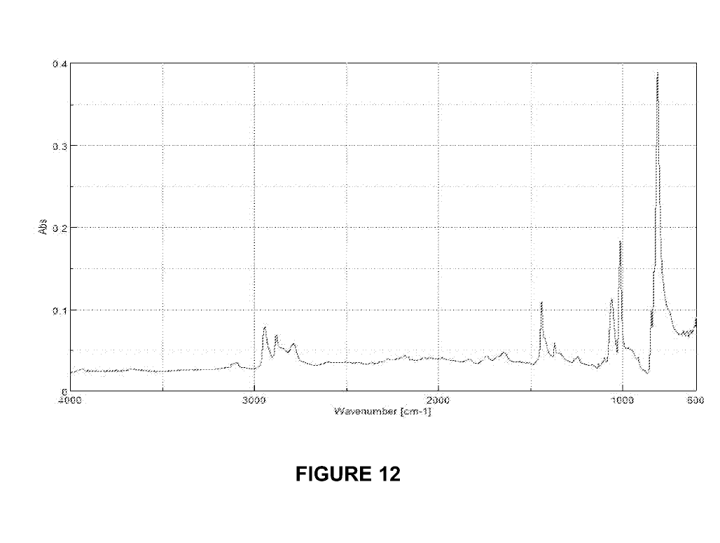

The ¹H NMR (FIG. 13) corroborates the FTIR (FIG. 6), however the integration ratios suggest the possibility of some silicon atoms having less than 3 silane protons per 5 axial and 5 equatorial C—H's, however the integration is ±10% of the expected values. Further, no significant νOH bands are observed at ≈3400 cm⁻¹. The FTIR analysis of the catalyst precursor Cp₂TiMe₂ is presented in FIG. 12.

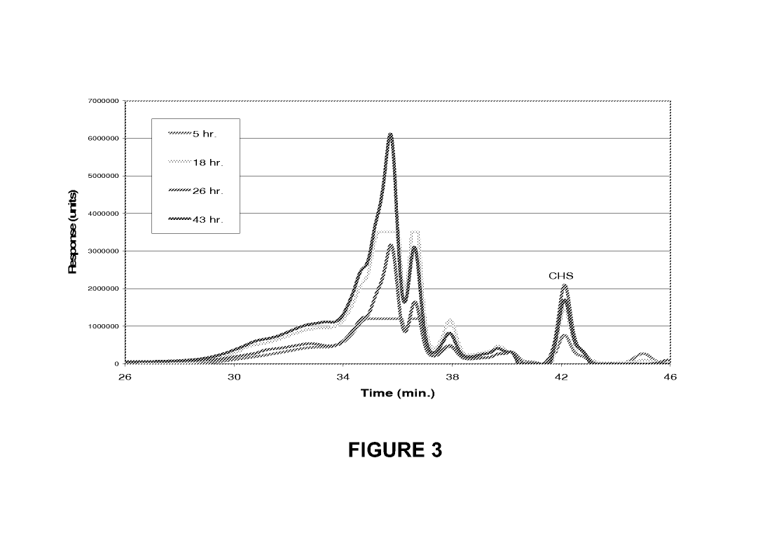

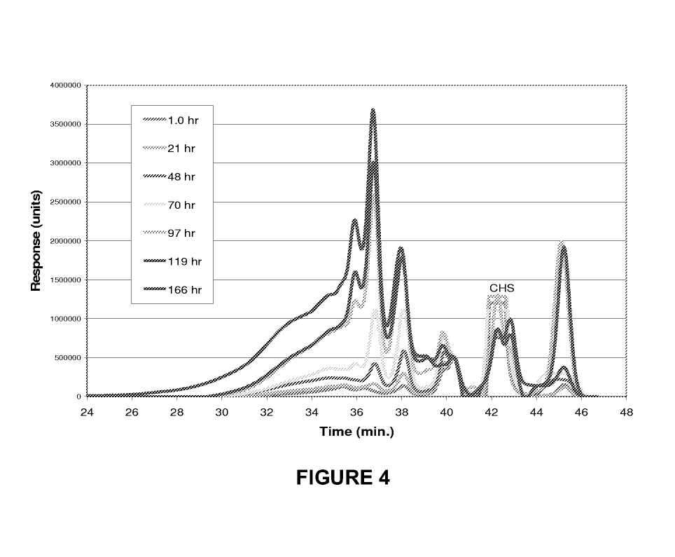

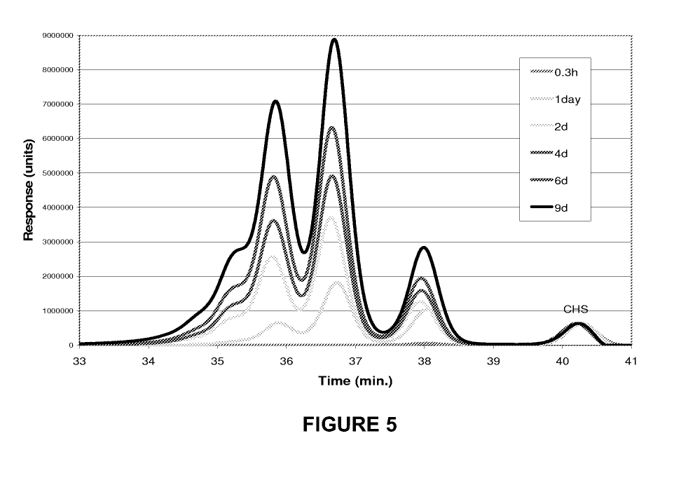

Cyclohexylsilane is then polymerized using 0.1-10 mol % of Cp₂TiMe₂ [Reaction (I-a)] either as a neat solution in cyclohexane solvent used to capture H₂. FIGS. 2-5 depict polymerization process studies under varied reaction conditions. FIG. 2 shows polymerization of cyclohexylsilane (neat, room temperature of about 25° C. (RT), with 10 mol % dimethyltitanocene (Cp₂TiMe₂) catalyst) samples taken at the indicated processing times ranging from 0.1-165 hours. FIG. 3 shows polymerization of cyclohexylsilane ((neat, 50° C., 10 mol % Cp₂TiMe₂ catalyst) samples taken after the indicated processing times ranging from 5-43 hours. The reaction shown in FIG. 3 is stopped at 43 hours due to high viscosity of the solution. FIG. 4 shows polymerization of cyclohexylsilane (toluene, RT, 10 mol % Cp₂TiMe₂ catalyst) samples taken after the indicated processing times ranging from 1-166 hours. FIG. 5 shows cyclohexylsilane (neat RT, 10 mol % Cp₂TiMe₂ catalyst) samples taken after the indicated processing times ranging from 0.3 hours to 9 days.

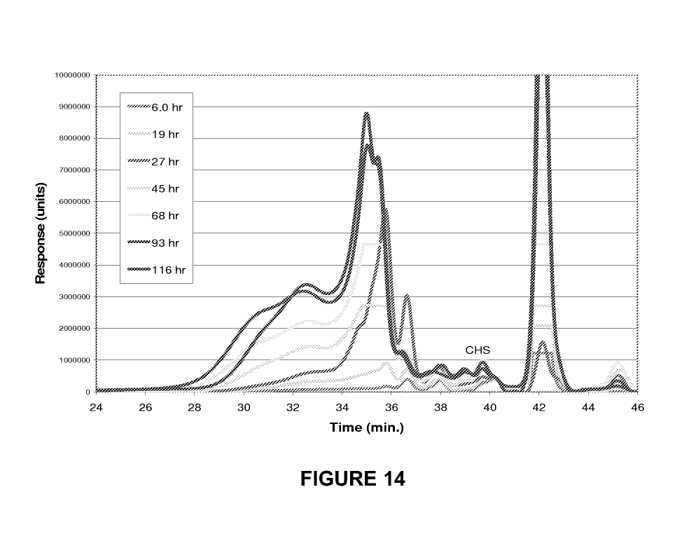

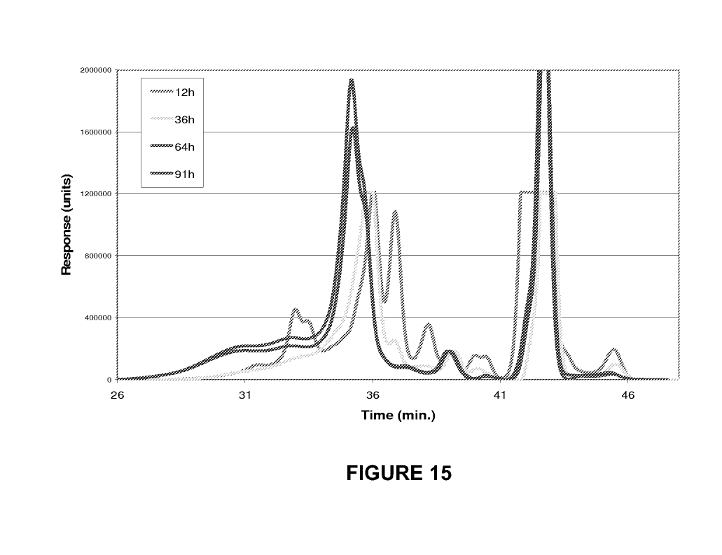

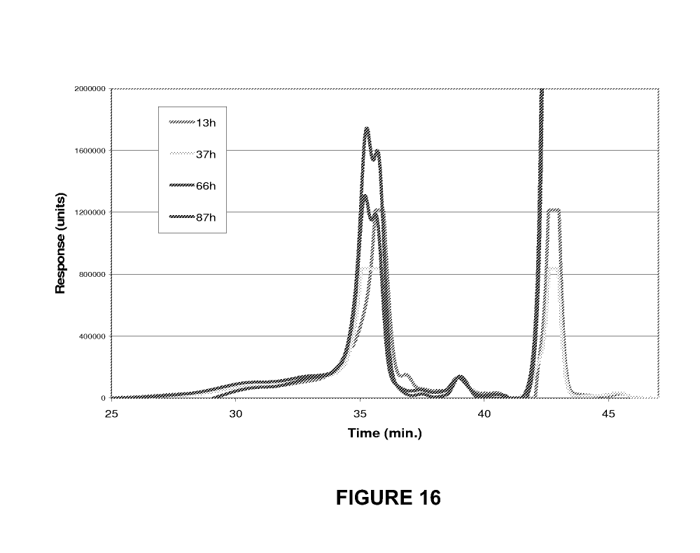

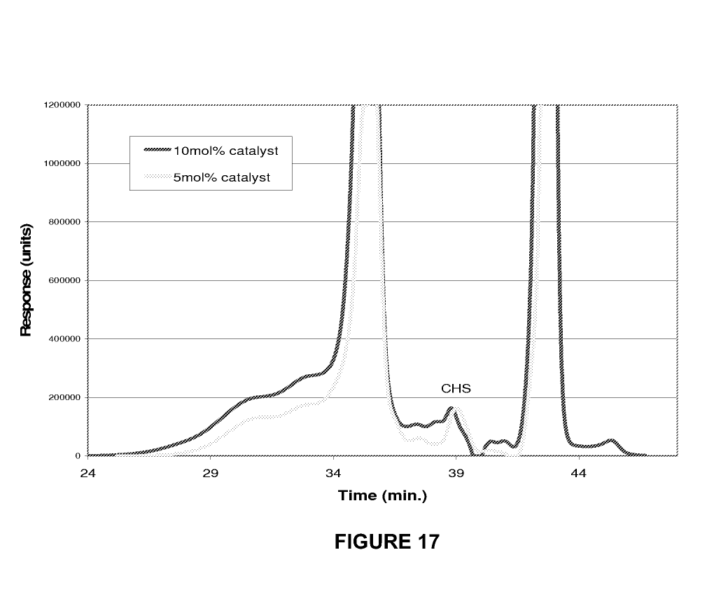

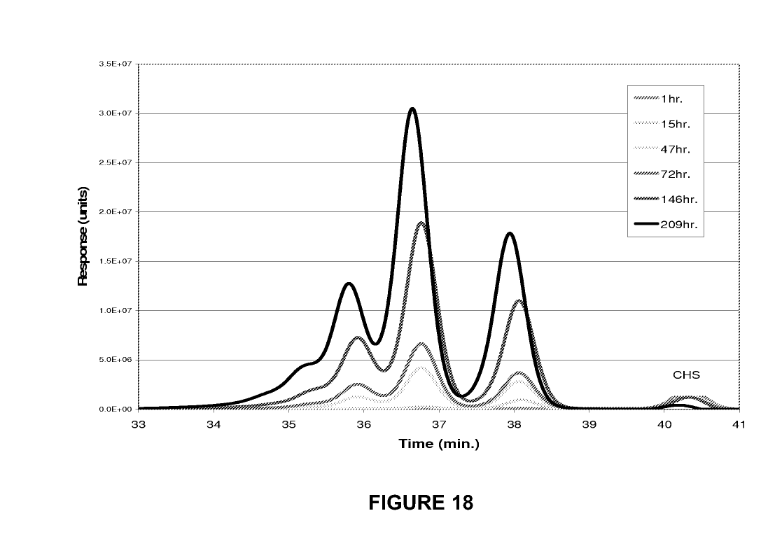

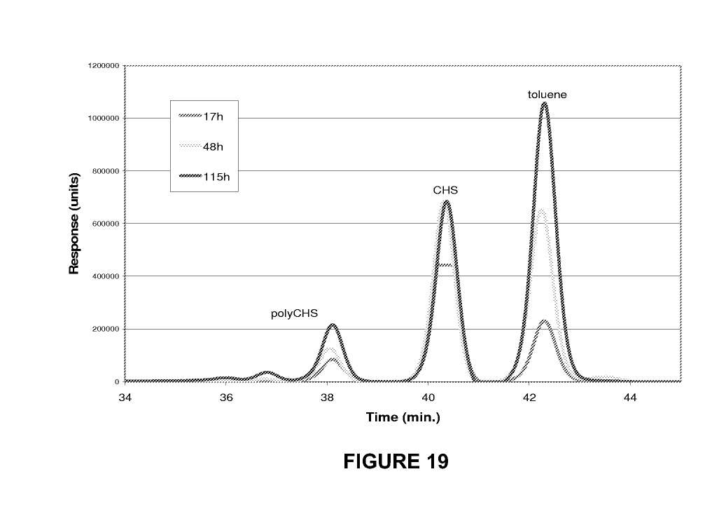

Similarly, FIG. 14 shows GPC analysis of a polymerized cyclohexylsilane sample ((in toluene at 50° C. with 10 mol % Cp₂TiMe₂ catalyst), with samples taken at processing times ranging from about 6 hours up to about 116 hours. The GPC analyses in FIG. 15 reflects a polymerized cyclohexylsilane sample ((in cyclohexene at 50° C. with 5 mol % Cp₂TiMe₂ catalyst), with samples taken after processing times ranging from about 12 to about 91 hours, as indicated. In FIG. 16, the GPC analyses are of polymerized cyclohexylsilane samples, which were taken at 90 hours of processing (in cyclohexene at 50° C. with either 5 or 10 mol % Cp₂TiMe₂ catalyst, respectively). FIG. 17 shows a polymerized cyclohexylsilane sample, where samples are taken after 90 hours of processing (in cyclohexene at 50° C. with 5 and 10 mol % Cp₂TiMe₂ catalyst, respectively). FIG. 18 has GPC analyses of a polymerization products of cyclohexylsilane (neat, at 50° C., 0.5 mol % Cp₂TiMe₂ catalyst) with samples taken after the indicated processing times. FIG. 19 is a graph showing GPC analysis of polymerization product of cyclohexylsilane using 0.1 mol % Cp₂TiMe₂ catalyst, with samples taken after the indicated processing times ranging from 17 to 115 hours.

Table 1 lists the GPC determined average number molecular weight (Mₙ), average weight molecular weight (M_{w}) and polydispersity indices of M_{w}/Mₙ (PDI) for the various polycyclohexylsilane products using polystyrene calibration standards. The GPC data suggest that polymerization results only in oligomers and/or cyclic including dimers, trimers and tetramers (with the assumption that polystyrene standards corroborate the molecular weights of these materials).

TABLE 1
Mₙ and M_{w} for Polycyclohexylsilane Products.

| Sample | Mn | Mw | Mw/Mn |
|---|---|---|---|
| neat, r.t., 10% cat. | 158 | 348 | 2.2 |
| toluene, r.t., 10% cat. | 183 | 609 | 3.3 |
| neat, 50° C., 10% cat. | 178 | 403 | 2.3 |
| toluene, 50° C., 10% cat. | 177 | 857 | 4.8 |
| cyclohexene, 50° C., 5% cat. | 149 | 419 | 2.8 |
| cyclohexene, 50° C., 10% cat. | 174 | 496 | 2.9 |
| cyclohexene, 50° C., 5% cat. | 180 | 535 | 3.0 |
| cyclohexene, 50° C., 10% cat. | 234 | 564 | 2.4 |
| neat, 50° C., 1.0% cat. | 326 | 346 | 1.1 |
| neat, 50° C., 0.5% cat. | 173 | 233 | 1.3 |
| neat, 50° C., 0.1% cat. | 117 | 125 | 1.1 |

(r.t. = room temperature; cat. = catalyst)

FIG. 6 provides FTIR data for the polycyclohexylsilane product illustrated in FIG. 5. The prominent peaks shown include νC—H at 2916 and 2846 cm⁻¹, νSi—H at 2100. Again there is no evidence for νSi—OH at 3400 or 990 cm⁻¹ typical for silanol groups.

TGA studies. Simple TGA runs are conducted to determine if the material decomposes with complete loss of the cyclohexyl rings. Multiple runs demonstrate that the oligomers produced in Table 1, all decomposed in Argon beginning at temperatures of 400° C. with ceramic yields at 800° C. of approximately 25 wt %. Pure Si theoretically has approximately 26%, thus these results indicate that indeed substantially all carbon is lost during pyrolysis.

The synthesis process is further refined, based on the variables studies discussed above and finally larger scale pyrolysis studies done in Zirconia boats. Such pyrolyses are run in sealed quartz tubes in an M-Blue furnace under an argon gas, heating to a final temperature ranging from about 600-1150° C., at heating rates of typically 1-2° C./min with intermediate dwell times at 350° C. and also at the final temperature for 1-6 hours, see FIG. 11.

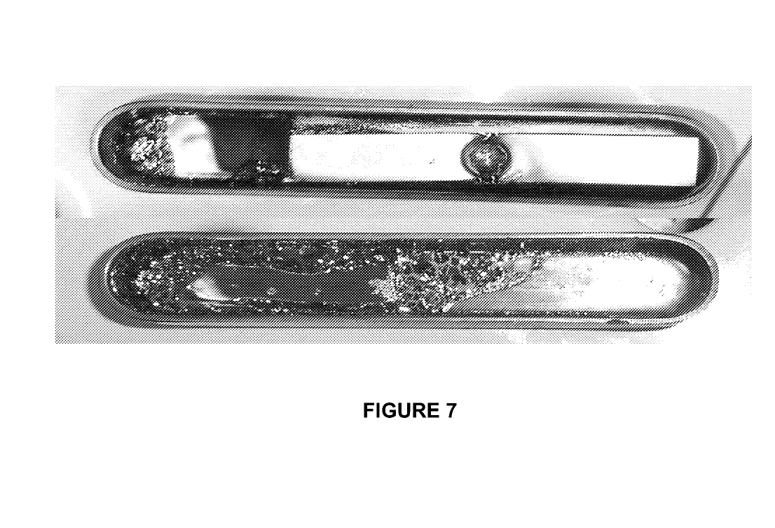

FIG. 7 shows pyrolysis products of polycyclohexylsilane. The products at the bottom of the boats are typically thin films as seen in the insert in FIG. 8. Analysis by electron dispersive spectroscopy (EDS) in FIG. 8 provides semi-quantitative indications that silicon (Si) is the major product with only traces of carbon (C), oxygen (O), and some titanium (Ti) from the catalyst.

The next step is purification of the oligomers via column chromatography prior to pyrolysis, as discussed below. The EDS observed C and O may arise simply from sample handling during transfer from the quartz pyrolysis tube to the SEM, which commonly occurs in such types of sample preparation. Alternately, it is possible that some small amounts of Si—O are introduced from adventitious impurities present during the synthesis of the monomer and or during oligomerization.

Catalyst Separation

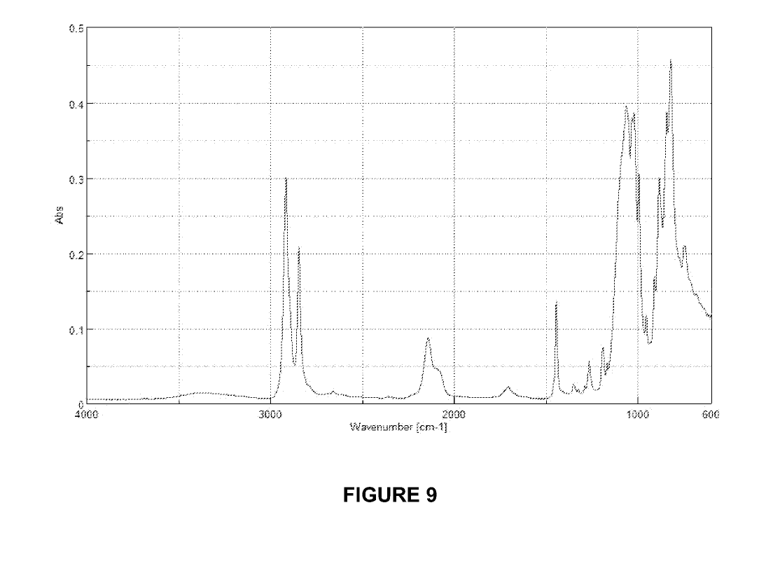

In this example, the titanocene catalyst is separated from the oligocyclohexylsilane product. Column chromatography with a presilylated silica gel column using hexane (N₂) as the eluent removes red colored catalyst intermediate as a ring at the top of the column leading to isolation of a yellow colored product. FIG. 9 shows the ATR-FTIR spectrum of this column purified material pre-purified poly-cyclohexylsilane.

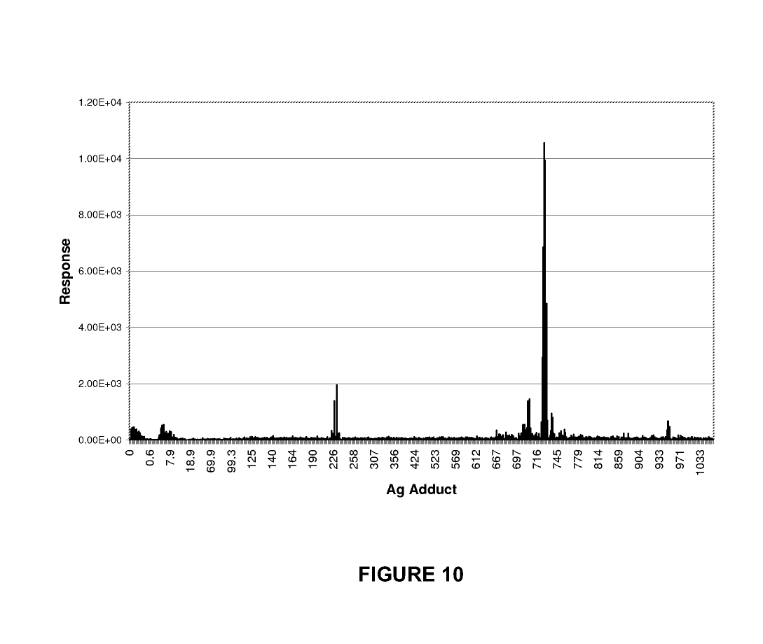

FIG. 9 indicates that considerable oxidation occurs during column chromatography as evidenced by the strong νSi—O peak near 1100 cm⁻¹. A MALDI-TOF spectrum of this purified product is shown FIG. 10. The structures suggested by the FTIR and MALDI-TOF analyses are as set forth below. The primary MALDI-TOF peaks are at ≈728 Da (Ag⁺ ion).

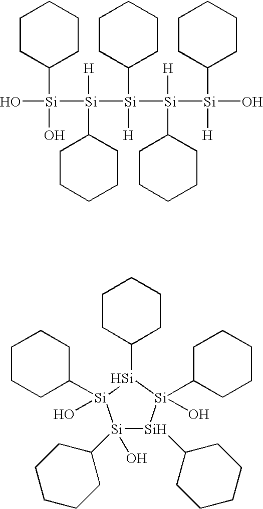

If it is assumed that a monomer unit is —[C_{ySiH]}ₙ— with a FW of 112 Da and one Ag⁺ 108 Da, then a calculation results in n=5.5, which does not accord with expected values based on empirical results. However, there is some evidence of hydroxyl (OH) peaks in the FTIR scan, indicating that the isolated product may have significant oxygen in it.

The TGA analysis of FIG. 11 of this partially oxygenated purified material shows a mass loss early however, the observed ceramic yield is 27%. A calculation based on —[CySiH]ₙ— with a formula weight of 112 that decomposes to SiHₓ should give a ceramic yield of 29/112=26%. Consequently it appears that even with traces of hydroxyl units the final product has an expected ceramic yield. It was observed that prior to column chromatography, where small amounts of catalyst remain that the ceramic yields, were frequently in the 27-29 wt % region indicating that the materials formed in accordance with the present disclosure are hydrogenated silicon.

When samples in zirconia boats are heated to 1100° C. in Ar, four point Hall Effect conductivity tests of large flakes (FIG. 8) are conducted. The conductivity measured in several places on several flakes was in the range of 10³-10⁴ Ω/square which is acceptable for commercial and/or industrial applications.

The description contained in the disclosure is merely exemplary in nature and, thus, variations that do not depart from the gist of the invention are intended to be within the scope of the present disclosure. Such variations are not to be regarded as a departure from the spirit and scope of the invention.

What is claimed is:

1. A method of making a hydrogenated silicon composition comprising:
forming a polysilane polymer according to the reaction represented by Reaction (I): 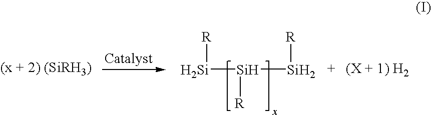
wherein SiRH₃ is a precursor silane compound that includes an R group comprising at least two carbon atoms and is selected from: linear alkyl groups, branched alkyl groups, cycloalkyl groups, and combinations thereof, wherein x is a molar amount of said precursor silane compound which reacts in the presence of at least one catalyst to form said polysilane polymer; and
decomposing said polysilane polymer for a duration and at a temperature sufficient to form the hydrogenated silicon.

2. The method according to claim 1, wherein said decomposing proceeds according to Reaction (II): 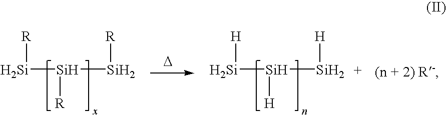
wherein n relates to the degree of hydrogenation, which relates to an amount of energy applied during said decomposing of the polysilane polymer.

3. The method according to claim 1, wherein Reaction (I) is conducted at a temperature of about 20° C. to about 60° C.

4. The method according to claim 1, wherein said R group is selected from: methyl, ethyl, n-propyl, isopropyl, n-butyl, 2-butyl, isobutyl, tert-butyl, n-pentyl, isopentyl, neopentyl, tert-pentyl, hexyl, heptyl, n-octyl, isooctyl, nonyl, decyl, dodecyl, n-dodecyl, cyclopentyl, cyclohexyl, cycloheptyl, methylcyclohexyl, and combinations and isomers thereof.

5. The method according to claim 1, wherein said R group is cyclohexane and said precursor silane compound is cyclohexylsilane.

6. The method according to claim 5, wherein said cyclohexylsilane precursor silane compound is formed according to Reaction (III) below:

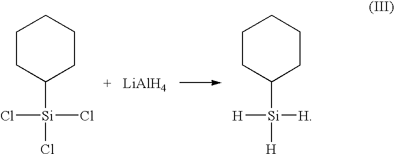

7. The method according to claim 5, wherein said Reaction (III) is conducted in a solvent comprising ether at a temperature of about −10° C. to about 10° C.

8. The method according to claim 1, wherein said at least one catalyst in Reaction (I) comprises dimethyltitanocene, hafnium, rhodium, zirconium, and combinations thereof.

9. The method according to claim 1, wherein said catalyst comprises dimethyltitanocene formed by reacting dichlorotitanocene with CH₃Li in an inert atmosphere to form the dimethyltitanocene.

10. The method according to claim 1, wherein said decomposing of said polysilane polymer is conducted in an inert atmosphere and said temperature is greater than or equal to about 350° C. and less than or equal to about 1,000° C.

11. The method according to claim 1, wherein said decomposing of said polysilane polymer is conducted in an inert atmosphere and said temperature is greater than or equal to about 600° C.

12. The method according to claim 1, wherein said decomposing of said polysilane polymer is conducted in an inert atmosphere and said temperature is greater than or equal to about 800° C.

13. The method according to claim 1, wherein said decomposing is conducted until the hydrogenated silicon composition contains less than 0.1% by weight hydrogen per total mass of the hydrogenated silicon composition.

14. The method according to claim 1, wherein said polysilane polymer is in a liquid and/or gel phase, and the method further comprises applying said polysilane polymer to a substrate to form a layer thereon after said forming and prior to said decomposing.

15. A method of making a hydrogenated semiconductor metalloid composition comprising:
forming a polymer comprising at least one semiconductor metalloid element according to the reaction represented by Reaction (V): 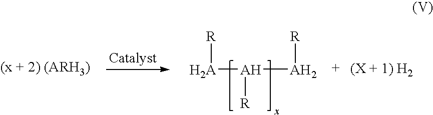
wherein A is selected from semiconductor metalloid elements: silicon (Si) and/or germanium (Ge); ARH₃ is a precursor compound that includes an R group comprising at least two carbon atoms and selected from: linear alkyl groups, branched alkyl groups, cycloalkyl groups, and combinations thereof, wherein x is a molar amount of said precursor compound which reacts in the presence of at least one catalyst to form said polymer; and
decomposing said polymer for a duration and at a temperature sufficient to form the hydrogenated semiconductor metalloid composition.

16. The method according to claim 15, wherein said decomposing proceeds according to Reaction (VI): 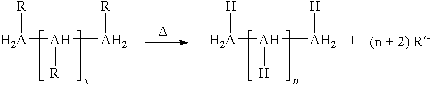
(VI), where Δ relates to an amount of energy applied and n relates to a degree of hydrogenation of the hydrogenated semiconductor metalloid composition, where said degree of hydrogenation relates to a duration and a temperature of said decomposing step.

17. A method of making a hydrogenated silicon composition comprising:
forming a polysilane polymer according to the reaction represented by Reaction (I): 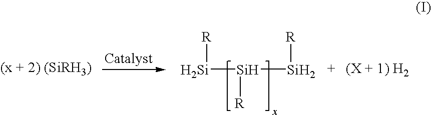
wherein SiRH₃ is a precursor silane compound that includes an R group comprising at least two carbon atoms and is selected from: linear alkyl groups, branched alkyl groups, cycloalkyl groups, and combinations thereof, wherein x is a molar amount of said precursor silane compound which reacts in the presence of at least one catalyst to form said polysilane polymer; and
decomposing said polysilane polymer for a duration and at a temperature sufficient to form the hydrogenated silicon, wherein said decomposing proceeds according to Reaction (II): 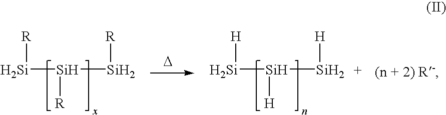
wherein x ranges from greater than or equal to about 5 to less than or equal to about 1000, and n relates to the degree of hydrogenation related to an amount of energy applied during said decomposing of the polysilane polymer and is greater than or equal to about 5.

18. The method according to claim 17, wherein said R group is selected from: methyl, ethyl, n-propyl, isopropyl, n-butyl, 2-butyl, isobutyl, tert-butyl, n-pentyl, isopentyl, neopentyl, tert-pentyl, hexyl, heptyl, n-octyl, isooctyl, nonyl, decyl, dodecyl, n-dodecyl, cyclopentyl, cyclohexyl, cycloheptyl, methylcyclohexyl, and combinations and isomers thereof.

19. The method according to claim 17, wherein said R group is cyclohexane and said precursor silane compound is cyclohexylsilane.

20. The method according to claim 17, wherein Reaction (I) is conducted at a temperature of about 20° C. to about 60° C. and Reaction (II) is conducted in an inert atmosphere and said temperature for said decomposing is greater than or equal to about 350° C. and less than or equal to about 1,000° C. and the hydrogenated silicon composition contains less than or equal to about 0.1% by weight hydrogen per total mass of the hydrogenated silicon composition.
